(19) United States
(12) Patent Application Publication
(10) Pub. No.: US 2003/0221399 A1
(43) Pub. Date: Dec. 4, 2003

(54) Changeable power implements

(76) Inventor: Glenn A. Hall, Naples, FL (US)

Correspondence Address: Glenn A. Hall, 3690 70th Ave NE, Naples, FL, 34120, US

(21) Appl. No.: 10/158,331

(22) Filed: May 31, 2002

(51) Int. Cl. A01D 1/00

(52) U.S. Cl. 56/2

(57) ABSTRACT

The invention is directed to a single power unit that can drive many different implements merely by taking one implement off the basic power unit and replacing it with another one. The different implements can be a concrete mixer, a snow blower, a roto-tiller or a cleaning brush. The implement can take the form of a leaf blower, a rotary lawn mower, a chipper or mulcher, an electric generator, an air compressor or a wagon box among others. The basic power unit has a horizontally driven power take-off shaft that is coupled to any one of the various implements that also have horizontally extending driven shafts that will connect whenever one of the various implements is connected to the basic power unit. The various basic implements are constructed in such a manner that each one of them can operate in the manner designed for them. Various reduction or increase gears are used to either speed up the working device or to slow it down as the end work requires. These modifications are in the implements only but not in the basic power driving unit which remains the same at all times. The two units are simply clamped together by clamping plates on either one of the unit or the implement.

### CROSS REFERENCE TO RELATED APPLICATIONS

(none)

### STATEMENT REGARDING FED SPONSORED R & D

(none)

### BACKGROUND OF THE INVENTION

The invention is directed to changeable power implements, such as, lawnmowers, lawn blowers, lawn edgers, mulchers, snow blowers, compressed air generators or electricity generators. All of the above named implements are well known because they are in abundant uses. One disadvantage of the above named implements is that they all have their own or individual power plants so that they can operate under their own power. It is quite possible that many home owners, especially landscapers or other shop facilities have several of the implements sitting in their garage ready to be used for a particular task. The inventive concept is directed to a multiple of implements having one power source to drive all of them.

Farm machinery is known to use different implements for such tasks such as mowing, raking, plowing and others. However, these implements are pulled behind the power source such as a tractor and the implements are all driven by power shaft connections e.t.c. to the tractor while the tractor can operate on its own without any implements being dragged there behind.

U.S. Pat. No. 2,770,894 discloses an invention that relates to improvements in snow removers and grass cutters of the rotary type which are interchangeably connected with and operated by power driven tractors and to power driven work devices having rotary work units detachably connected thereto. The power is conveyed by belts or chains.

U.S. Pat. No. 3,596,450 illustrates an adapter system and attachments therefor which utilizes the structural and drive features of a powered lawn mower inclusive of the cutter blade-fan to provide additional power rake, brush, edger and non-scalping features.

U.S. Pat. No. 3,945,176 illustrates a power driven rotary lawn mower in which an auxiliary power drive is provided to a tine bearing shaft. This combination permits thatching, grass cutting and mulching, all at the time, depending on the position of the tine bearing shaft. There is also a rearwardly mounted seed drill for immediately reseeding of a thatched lawn.

U.S. Pat. No. 4,532,725 shows a rideable work apparatus having attachments that include a snow plow, a lawn mower and a roto-tiller simultaneously mounted to a frame. Cranks are provided for selectively actuating each of the attachments.

U.S. Pat. No. 4,278,133 discloses a motor powered lawn edger which can be converted to a lawn cultivator, a snow blower or an ice chipper by removal of the lawn edging blade and its housing and thereafter substituted by a different housing having the appropriate tools.

U.S. Pat. No. 5,520,253 illustrates a basic structure and a collection of components to improve on the efficiency in caring for lawns and gardens. The basic structure comprises a single engine, a speed reducer and a transmission mounted on a frame with handle bars and controls. The components make up a collection of tines, wheels, blades, rollers, plows, racks an mounting parts. The operator mounts selected components on the basic structure to create a custom ramification for accomplishing a specific task.

U.S. Pat. No. 6,256,970 shows a mobile lawn maintenance having a vertical drive shaft driving a forward vertical shaft by way of a belt. The bottom ground contacting end of the vertical drive shaft has means for accepting various and different working implements thereon.

### BRIEF SUMMARY OF THE INVENTION

The basic inventive concept involves a basic power unit having two wheels, a handle bar with controls thereon to control the power of the engine mounted above the wheels. The engine has a horizontal drive shaft having at one end thereof a splined receptacle. The various implements mentioned above have another set of wheels to achieve a stable structure maneuverable over the ground. Any of the above mentioned implements have the same connecting features that match connecting features on the basic power unit. The implements have a splined drive shaft that matches the splined receptacle power drive on the basic power unit when connected thereto. The basic power unit is only half of all the other implements and can only operate when connected thereto. There is a clamping mechanism that easily connects the power unit to the other implements.

### BRIEF DESCRIPTION OF THE DRAWINGS

FIG. 1 illustrates the basic power unit which drives the changeable implements;

FIG. 2 shows the implement as a cement mixer;

FIG. 3 shows the implement as a snow blower;

FIG. 4 shows the implement as a rotary brush surface cleaner;

FIG. 4a shows the implement of FIG. 4 having a roto-tiller unit thereon;

FIG. 5 shows the implement as a leaf blower;

FIG. 6 shows the implement as a rotary lawn mower;

FIG. 7 shows the implement as a mulcher or chipper;

FIG. 8 shows the implement as an electric generator

FIG. 9 shows the implement as an air compressor;

FIG. 10 shows the implement as a wagon box;

FIG. 11 shows the end of a splined drive shaft to match the female drive shaft of FIG. 1;

FIG. 12 illustrates a plate to plate clamping mechanism in perspective view;

FIG. 13 is the clamping mechanism of FIG. 12 in a side view.

### DETAILED DESCRIPTION OF THE INVENTION.

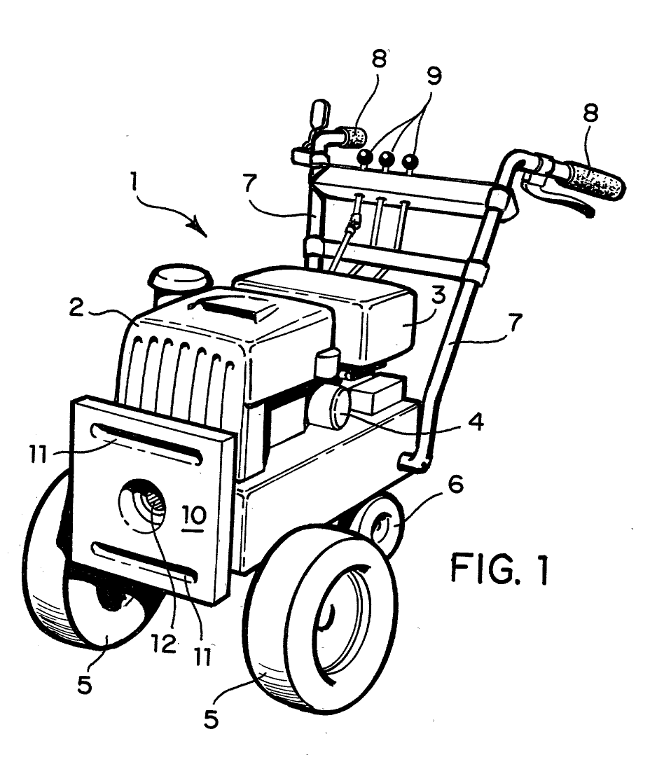

FIG. 1 shows the overall power unit which can easily be connected to all the implements shown and explained hereafter. The power unit shown at 1 can be a standard low horse power drive engine of a two or four cycle system shown at 2. As is well known, the numeral 3 shows a gas tank with the air intake for the engine shown 4. The basic unit has front wheels 5 which may be driven (not shown) or just may be moved along with the basic unit as it moves across the surface of the ground. At the rear of the basic unit there are mounted one or two idler or caster wheels 6. Although not essential, the idler wheels 6 are used to stabilize the unit when not in use. The power unit 1 is handled and moved about by the handle bars 7 as is well known on lawn mowers and other devices. The upper ends of the handle bars have handle grips 8 attached thereto. On a cross piece of the handle bars there are mounted the various control levers which is also well in the art.. The front of the power unit has attached thereto a mounting plate 10 which serves to mount the various implements having a like plate, as will be explained below. The mounting plate has stabilizing depressions 11 therein. the implements will have similar protrusions on their plates to match the depressions 11 as the explanation continues below. The engine in this application is designed to have a horizontal crank shaft (not shown) so that the power takeoff for the respective implements will be in a horizontal manner. Thus, the power takeoff in FIG. 1 is shown at 12 as a female interiorly splined shaft. The reason that a female splined shaft is used is for safety reason. Were a male shaft be used, it would be protruding from the front plate as at 12 and when operating and thereby turning, the protruding shaft would pose a safety hazard. The power unit 1 could easily be moved to any desired location because of the wheels 6 and 6.

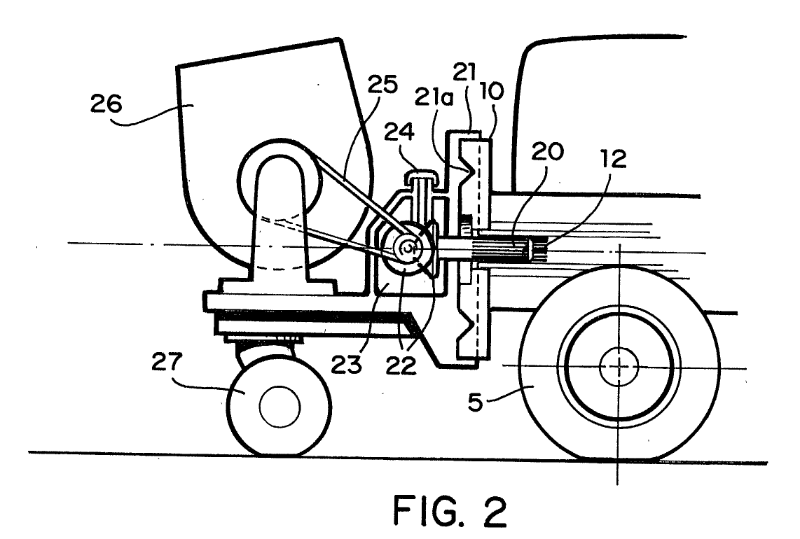

Turning now to FIG. 2, there is shown the first replaceable in the form of a cement mixer. The power unit 1 is only shown schematically by illustrating the front wheels 5 and the female splined connector 12. In this FIG. 2, there is also shown the front connecting plate 10. The male connecting splined connecting shaft is shown at 20. The cement mixer implement has a connecting plate at 21 with connecting protrusions shown at 21a which will settle in the depressions 11 shown in FIG. 1 for reasons of stability. The cement mixer implement has a drive mechanism in the form of miter gears 22 in the oil or grease box 23 having a dip stick 24 to observe any present oil or grease level. The concrete tub of known construction and drive is receiving its power by way of a belt drive 25 which is driven from the basic power unit 1. The front 27 wheels can be idler or caster wheels.

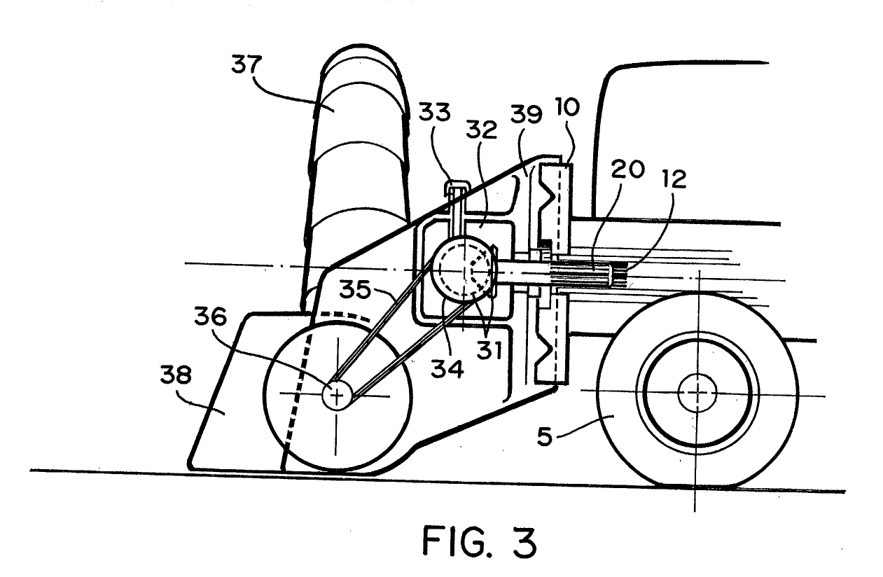

FIG. 3 shows the implement as a snow blower. To this end, the internal female splined drive connection is shown at 12 as previously described. The male splined connection is shown at 30. As is well known, a snow blower needs a high speed turbine which has the force to blow the snow away from the implement. The male drive shaft 30 drives a miter gear 31 which in turn drives a large drive belt wheel 34 which by way of a belt 36 drives a smaller belt wheel 36. Therefore, the speed of rotation to the spiral scraper inside the housing 38 (not shown) is greatly increased. such snow blowers are well known in the art. The snow is blown out of the chute 37 away from the implement. The miter gears 31 are contained in a grease or an oil box 32 having a visual observation of the level of the substance therein by way of a dip stick 33

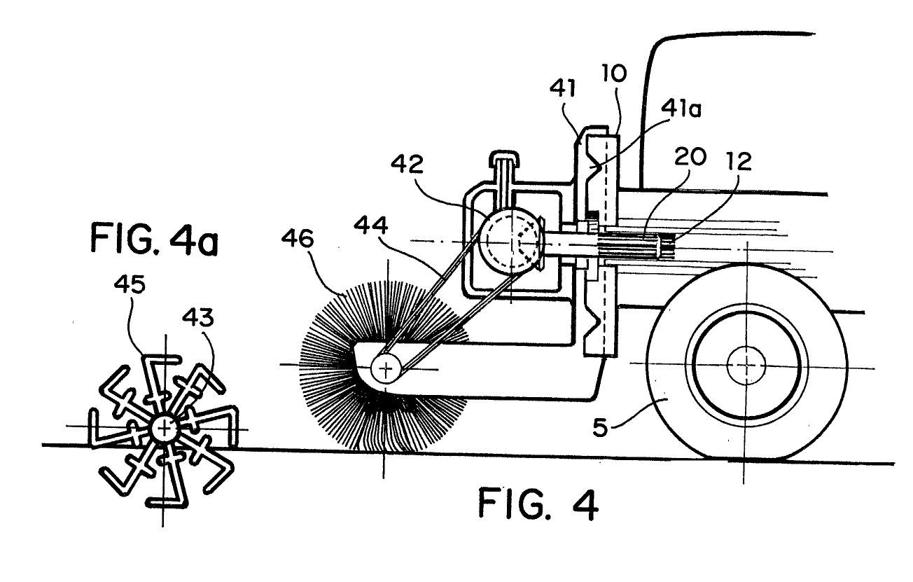

FIG. 4 shows the implement as a sweeper brush. Again, the basic elements of the power unit are shown by using the same reference characters as were used in previous Figs. above. The wheels are shown at 5 and the internal female drive shaft is schematically shown as the driven shaft in the same manner as was the snow blower in FIG. 3. The connector plate of the basic power unit is shown at 10, while the connector plate of the implement is shown at 41. 41a again indicates the protruding bars which fit into the stabilizing slots 10 in FIG. 1. In FIG. 4, the belt drive wheel is shown at 44 being driven by the belt drive pulley 42 of a larger diameter which would increase the speed of the brush element 46 to some considerable extent.

FIG. 4a shows a roto-tiller element 45 being driven by the belt 44. The roto-tiller element 45 is installed on the same shaft on which the rotary brush element 46 is mounted. This allows the same implement to be converted from a cleaning unit as a surface cleaning device to a roto-tiller unit to cultivate the ground. In case the implement is used as a roto-tiller, it should be noted that the implement should be oriented at a different position so that the tiller unit 45 can dig deeper into the ground. This can easily be accomplished by removing the caster wheels 6 FIG. 1. This allows for a different orientation of the power unit 1.

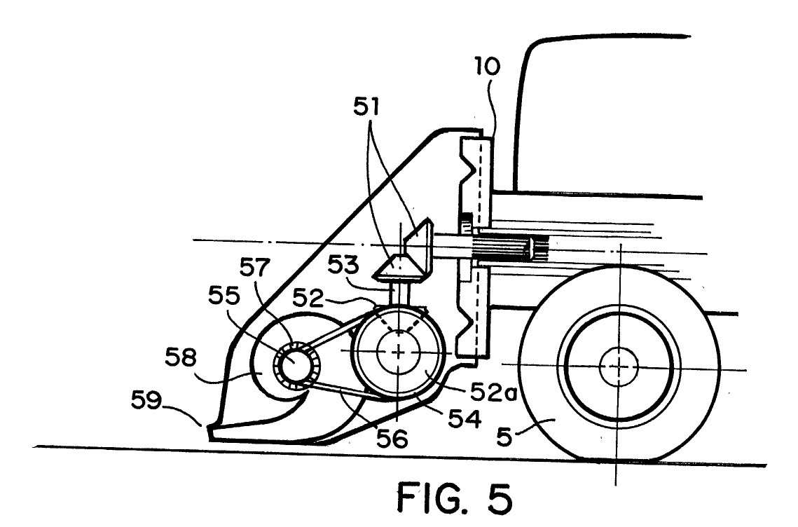

FIG. 5 shows the implement to be a leaf blowing implement. By now, it should be realized and understood that the basic elements of the basic power unit are used over and over again to obtain the end result. The same reference characters are used as in previous explanations. Therefore, the numeral 5 indicates the front wheel of the power unit 1. The numeral 10 indicates the front attachment plate. The miter gear 51 drives a lower shaft 53 which in turn drives a lower miter gear 52 which in drives an intermediate gear 52a which in turn drives a large belt wheel 54. A belt 56 drives a small diameter belt wheel 55 which in turn drives a turbine 57. The turbine 57 is located in a spiral housing 58 which exhausts air out of the air outlet 59. The turbine effect of a leaf blower is well known and does not need any further explanations.

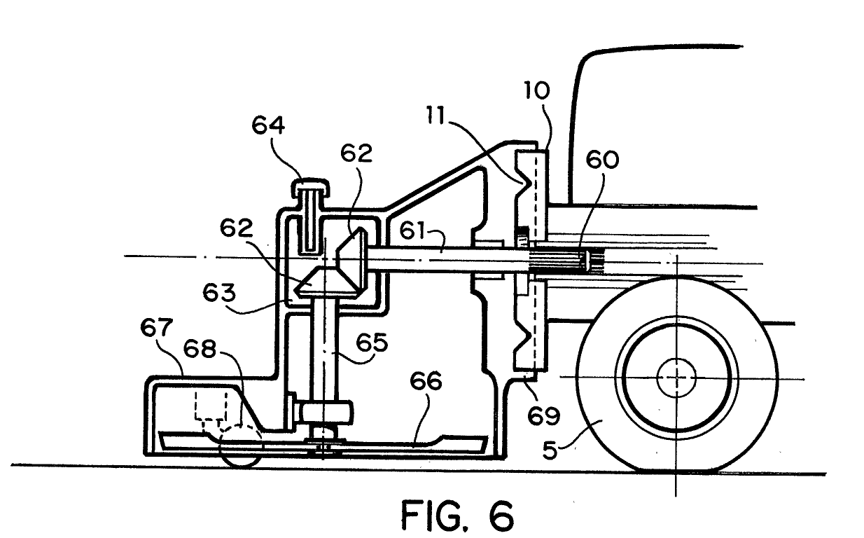

FIG. 6 shows the typical construction of a rotary lawn mower. To this end what needs to be explained how the rotary blade is being driven from the basic power unit 1 of FIG. 1. The basic power unit 1 is shown in FIG. 6 by its front wheel 5. As is well known by now is the male splined drive shaft 60 deriving its power from the female drive shaft 12 in FIG. 1. The horizontal drive shaft 61 drives the miter gear 62 to drive a vertical shaft 65. The miter gear 62 is contained in a grease or oil box 63. The level of grease or oil in the box 63 is visually controlled by a dip stick 64. The rotary cutting blade 66 is attached to the vertical drive shaft 66 which is contained within the housing 67. The front of the implement of the lawn mower may be stabilized by front wheels 68.

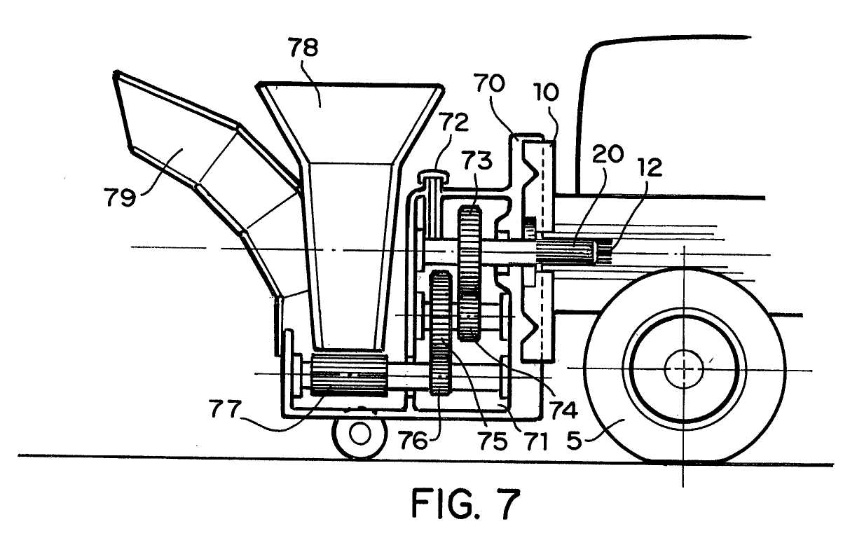

FIG. 7 illustrates an implement in the form of a mulcher or a chipper. To this end, the basic power unit again is shown with the front wheel 5 and the splined female power connection at 12. Also, there is shown the connector plate of the power unit at 10 and the connector plate on the implement at 70. The male splined power drive connection is shown at 20. The mulcher or chipper drum is shown at 77. This drum needs a powerful but slow drive in order to accomplish the mulching and chipping it is designed to do. Therefore, the drive involves a gear reduction with two upper gear reductions 73 and 74 and the further reduction gears 75 and 76. Both gear reduction are contained in a gear grease or oil box 71 having a dip stick 72 for observing the level of the oil or grease within the box. FIG. 7 further shows a feed chute for feeding the material to be chipped up and at 79 as shown an exhaust funnel where the torn up material is being ejected. Of course, there is a turbine (not shown) to accomplish the ejection, which is well known in the art.

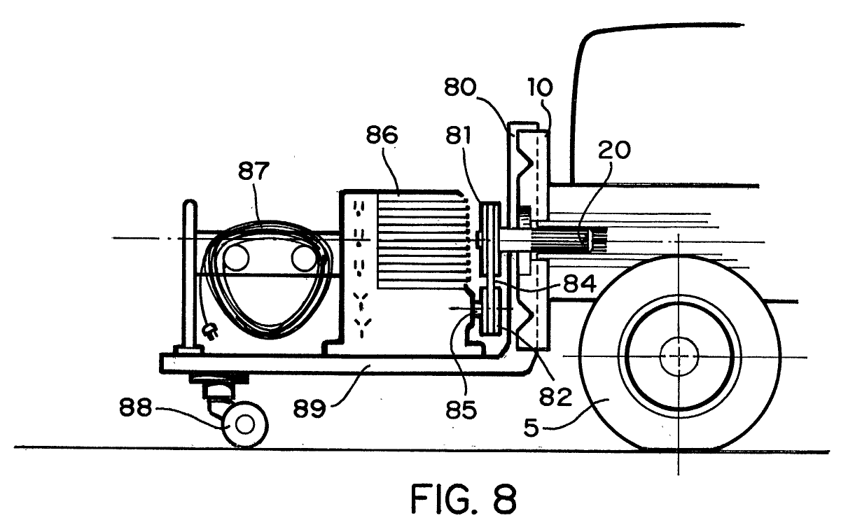

FIG. 8 shows the implement as an electric generator to produce electricity. The basic power unit again is shown with its front wheel at 5 and the Front connector plate at 10. The implement has a corresponding connector plate 80 and shows the male splined drive connector at 20. The drive shaft 20 drives a large upper belt pulley which drives the lower smaller belt pulley 82 by way of the belt 84. This constitutes a faster drive for the generator shaft 85 of generator 86 which must be driven at high speed to generate the appropriate electrical power. 87 indicates the necessary extension cord. The components of the electric generator are mounted on a platform 89 which has a front caster wheel 88.

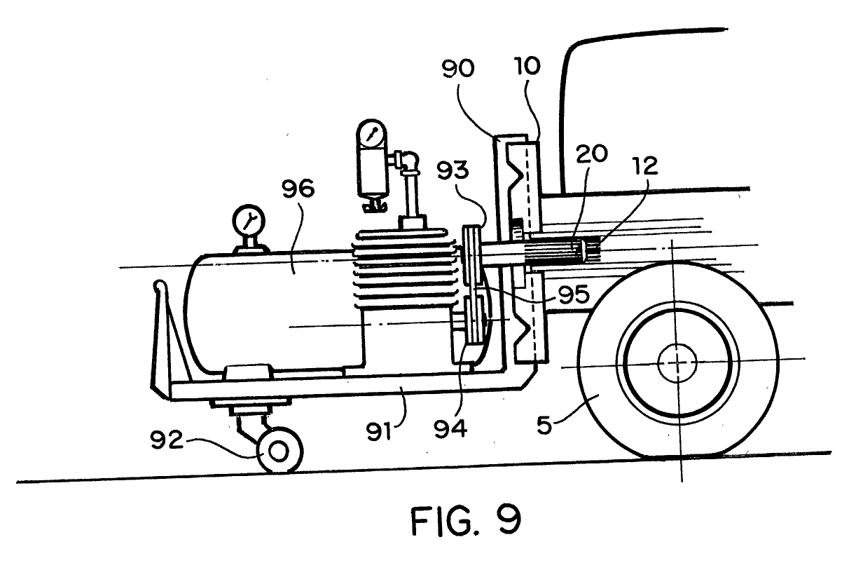

FIG. 9 represents an implement in the form of an air compressor. Again, the basic power unit is shown with its front wheel 5 and the female splined connection shaft 12 and the male splined connection shaft 20 which is located on the implement to be able to drive the individual components of the air compressor implement. Also, there is shown the front connector plate 10 on the basic power unit which will be clamped to the connector plate 90 on the implement. The male splined drive shaft 20 drives a belt pulley 93 of a smaller diameter which by way of a belt 95 drives a belt pulley 94 having a larger diameter. It is a well known fact that an air compressor power shaft is driven at a somewhat lower speed but requiring more power. This is what is shown in the transmission belt drive. All of the components of the air compressor are mounted on a support frame 91 having a front idler wheel 92.

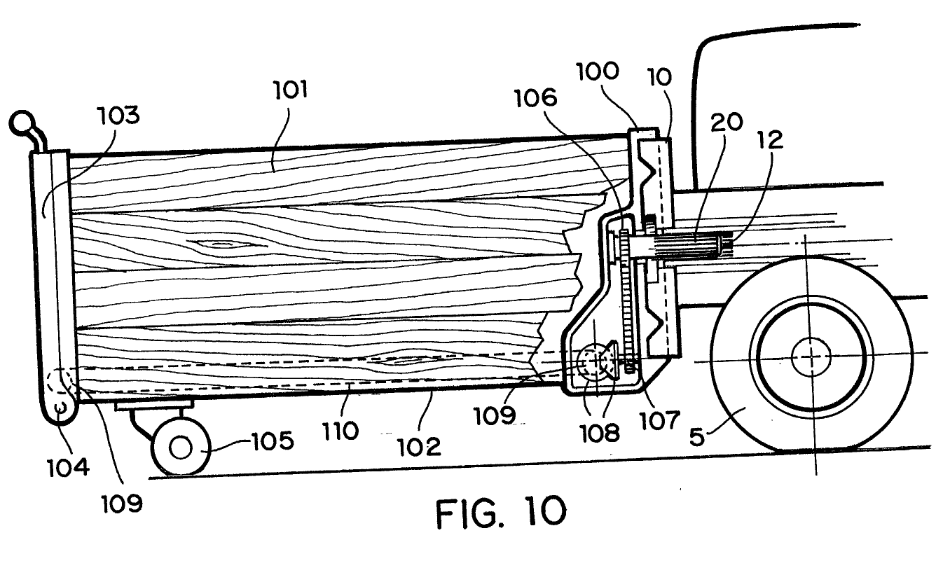

FIG. 10 shows the use of a wagon box wherein the basic power unit is shown with its front wheel 5 and the front connecting plate 10 which will be connected to the connector plate 100 on the wagon box by way of clamping which will be described below. The drive 120 on the wagon box could be used to drive a continuous loop conveyor belt 1 10 in the bottom of the wagon box to transport materials therein from one end to the other. The drive for the loop belt 110 can be derived from the drive shaft 120 by way of a sprocket drive and chain 106 and 107 to drive a lower miter gear 108 which in turn will drive a drive shaft 109 to drive the continuous belt 110. The wagon box could be constructed of removable side boards 101 and if removed would leave just a bare bottom bed frame 102 so that odd shaped items could be transported thereon. It is helpful to include the front caster wheel 105 on the wagon box to stabilize the bottom frame 102 when not in use. It is also helpful to have the rear gate 103 which is hinged at 104. This rear gate 103 is useful as a ramp when in a down position so that other items can be wheeled onto the bottom bed frame 102

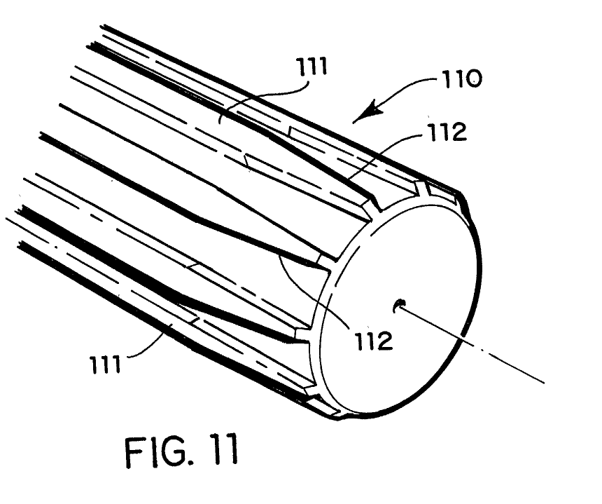

FIG. 11 shows the male spline connector in an enlarged version. It stands to reason that it the spline connection were not modified, as will be explained, the splines 111 would be damaged after a prolonged use, that is, the end faces of the splines would be hitting head on with the spline end faces on the interior of the female connector. Therefore, the splines 111 are reduced in their width direction as is shown at 112. In this manner, whenever the male splined connector shaft is introduced into the female splined connector, no flat faces of the splines will hit head on but, because of the modifications made, the splines will automatically pass each other, that is, self-adjust without causing any damage to each other.

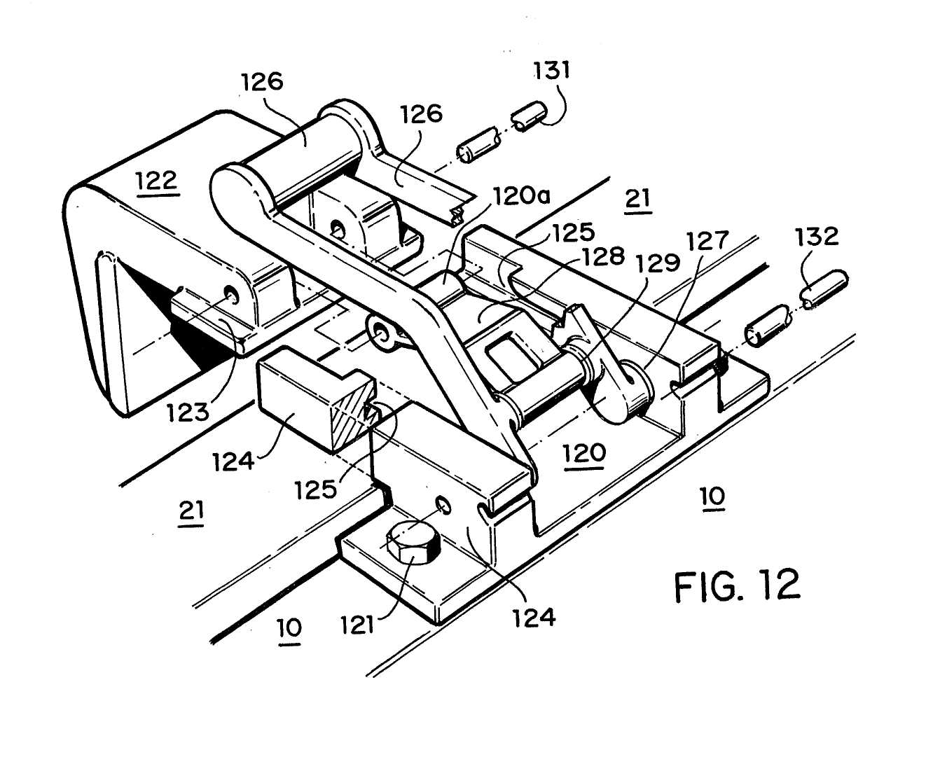

FIG. 12 shows a clamping mechanism in a perspective view. To this end, the forward clamping plate of the basic power unit 1 is shown at 10 and the rearward clamping plate of all of the implements is shown at 21 and in FIG. 2. The reference character for this clamping plate 21 changes from implement to implement but can easily identified in the various views. In FIG. 12, a clamping bracket 120 is mounted on the clamping plate 10 at various locations around the periphery of the the basic power unit. It stands to reason that at least two such clamps must be used if not more to assure a secure clamping of the clamping plates to each other. The clamping bracket 120 is fastened to the to the clamping plate 10 by of bolts 121. There is a clamping claw 122 connected to the clamping bracket 120 by way of various intermediate and movable parts as will be explained below. The clamping claw 122 wraps itself around the edge of the clamping plate 21 so that the plates 10 and 21 are in a tight engagement when clamped together. On each side of the clamping bracket 120 there located two sliding blocks 124 with each having a groove 125 therein which face each other. At the bottom of the rear end of the clamping claw 122 there is a plate 123 having slight extensions as shown at 123. These extensions slide into the grooves 125 when the clamping claw 122 is moved relative to the two slide blocks 124 and over the clamping plate 21. The movement of the clamping claw is effected by the handle 126 which is pivotally mounted at 127 on both the sliding blocks 124. The handle 126 has a plate 128 mounted thereon at 129. The other end of the plate 128 is attached to the clamping claw 122 by way of the pivot sleeve 120a and a pin 131 passing through the pivot sleeve 120a and the clamping claw 122.

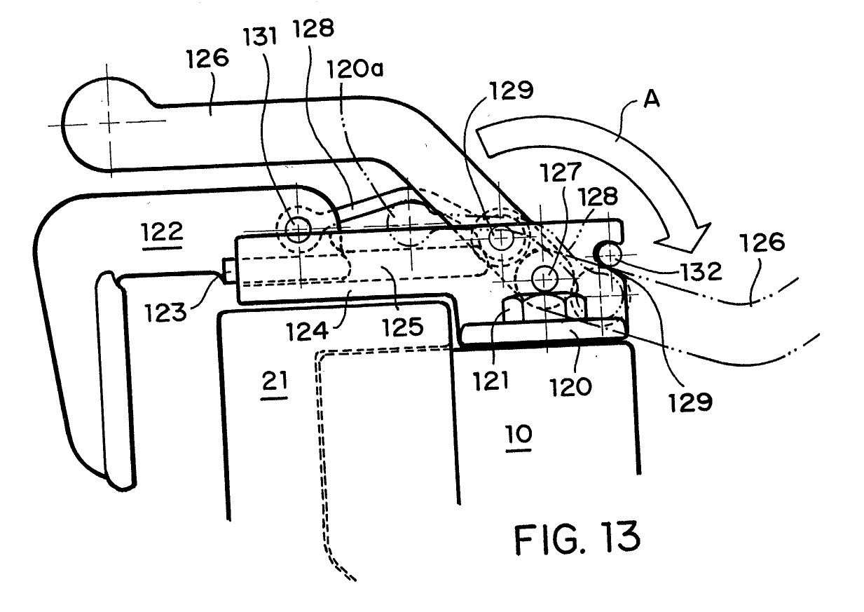

FIG. 13 shows the clamping mechanism of FIG. 12 in a side view with like reference characters of FIG. 12 applied to the same elements in FIG. 13. The operation of the clamping mechanism of both Figs. will now be described. The handle 126 is moved around its pivot and as is shown by the arrow A. As a consequence the link 128 is moved in its own path because of its off-center connection 129 with pivot 127 of the handle. In view of its connection at 131 with the clamping claw 122, the claw 122 starts to move toward the plate 21. A continued movement of the handle 126, arrow A, results in the claw 122 making tight contact with the clamping plate 21 in a clamping manner. At this point the handle has reached a position as shown in dot-dash lines (FIG. 13). In this position a pin 132 is inserted through the openings in the bracket 120. This will prevent the handle 126 from leaving this position either on its own because of the clamping pressure or because of the vibration caused by the operation of the power unit and the implement attached thereto.

What I claim is:

1. A power driving unit and implement combination comprising a basic and single power unit having means thereon for driving a female drive shaft in a horizontal rotation,
A multiple of different implements, each of said multiple implements having means thereon for being drivingly connected to said female drive shaft
each of the means on said multiple of implements is a horizontal male drive shaft, said female drive shaft will drive said male drive shaft when interconnected to each other.

2. The power driving unit and implement combination of claim 1, wherein said female drive shaft has splines therein and said male drive shaft has splines thereon, said splines in said female drive shaft and said splines on said male drive shaft match each other when interconnected to transfer power from said female drive shaft to said male shaft.

3. The power driving unit and implement combination of claim 1 including means for connecting said power driving unit and any one of said implements to each other in a rigid manner

4. The power driving unit and implement combination of claim 3, wherein said means for rigidly connecting comprises a plate mounted on a front of said power driving unit and another plate mounted on each of the implements, means for clamping said plates together.

5. The power driving unit and implement combination of claim 4, wherein one of the plates has at least one stabilizing depression therein and wherein the other of said plates has a protrusion thereon to match said at least one depression with said at least one protrusion.

6. The power driving unit and implement combination of claim 1, wherein the power of said power driving unit is derived from an internal combustion engine driving said female power shaft.

7. The power driving unit and implement combination of claim 1 including handle bars mounted to a frame of said power driving unit.

8. The power driving unit and implement combination of claim 7 including control handles mounted on said handle bars.

9. The power driving unit and implement combination of claim 1, wherein one of said implements that has said horizontal male driving shaft drives a miter gear having a relatively small belt pulley attached to an output of said miter gear, said relatively small pulley drives a relatively large belt pulley, both pulleys are connected to each other by a driving belt, said relatively large belt pulley drives a concrete mixing tub.

10. The power driving unit and implement combination of claim 9, wherein another one of said implements utilizes said miter gear to drive a downwardly extending shaft which drives a further miter gear having a relatively large belt pulley attached thereto which in turn is driving a relatively small belt pulley attached to a horizontal shaft by way of a belt, said horizontal shaft supporting a snow scraper as in a snow blower.

11. The power driving unit and implement combination of claim 10, wherein in another one of said implements said belt driven horizontal shaft has a roto-tiller unit attached to said shaft to establish means for roto-tilling a ground surface.

12. The power driving unit and implement combination of claim 10, wherein in another one of said implements said belt driven horizontal shaft has a circular brush attached to said horizontal shaft for cleaning horizontal hard surfaces.

13. The power driving unit and implement combination of claim 10, wherein in another one of said implements said belt driven horizontal shaft has an air turbine attached thereto which is located in a spiral housing, said turbine and turbine housing establishing a means for blowing leaves and other debris.

14. The power driving unit and implement combination of claim 1, wherein said male shaft of another implement drives a miter gear including a downwardly extending shaft, said downwardly extending shaft having a rotary blade attached thereto, said rotary blade performing the task of a rotary lawn mower.

15. The power driving unit and implement combination of claim 1, wherein one of said implements includes a wagon box, said wagon box having removable side boards to obtain a flat horizontal surface, said wagon box having a hinged rear gate which is movable downwardly to establish a ramp.

16. The power driving unit and implement combination of claim 15, wherein said horizontal surface has a continuous conveyor belt installed thereon including means for driving said continuous belt from said power driving unit.

17. The power driving unit and implement combination of claim 2, wherein said splines of said male shaft are reduced in width toward the end of the shaft to avoid collisions of the ends of the splines when encountering the end faces of the female splines.

18. The power driving unit and implement combination of claim 4. wherein said means for clamping comprises a clamping mechanism having one end attached to said clamping plate on said power unit and another end having a clamping claw which claw when activated will clampingly engage said clamping plate on each of said implements

19. The power driving unit and implement combination of claim 1, including a handle operatively connected to said clamping claw, said handle is pivotally connected to a bracket on said clamping plate on said power unit, a connector plate is pivotally connected at one end to said handle in an off-set manner from the pivot of said handle and with another end to said claw, whereby, when said handle is rotated, said handle will move the said connector plate along including said claw until said clamping claw makes contact with said clamping plate on said implement, means for arresting said handle in place once contact is made between the clamping claw and said clamping plate on said clamping plate on said implement.
